(19) United States
(12) Patent Application Publication
(10) Pub. No.: US 2014/0300093 A1
(43) Pub. Date: Oct. 9, 2014

(54) GAS GENERATOR HOUSING FOR AN AIR BAG

(71) Applicant: DSM IP ASSETS B.V., Heerlen (NL)

(72) Inventors: Jozef Willem Hendrik Bellemakers, Echt (NL); Andy Rose, Echt (NL)

(21) Appl. No.: 14/359,710

(22) PCT Filed: Nov. 22, 2012
(86) PCT No.: PCT/EP2012/073367

§ 371 Date: May 21, 2014

(30) Foreign Application Priority Data
Nov. 24, 2011 (EP) 11190477.7

(51) Int. Cl. B60R 21/264

(52) U.S. Cl. CPC B60R 21/264
USPC 280/741

(57) ABSTRACT

Gas generator housing for an air bag containing one or more parts of a polymer composition, wherein each part of the polymer composition is a hemispherical part.

The invention relates to a gas generator housing for an air bag. Air bags are used as safety device in cars to protect occupants from a collision. Usually a gas generator for an air bag contains a housing with a combustion chamber enclosed therein, into which chamber a pyrotechnic solid propellant is filled. To activate the solid propellant, normally an igniter is provided, which is inserted into an opening of the housing and projects into the combustion chamber. In the wall of the housing there are several outflow openings for the gases which are released on combustion of the propellant. The gasses are supplied to the air bag, which is stored in the air bag container.

The gas generator housings for air bags are produced of metals. This is because the gas container housing has to be able to withstand very high internal pressure, caused by the explosive release of the gases in the combustion chamber.

From WO98/19895 a gas generator housing comprising two parts of a fibre reinforced thermoplastic polymer composition is known. The parts comprise a cylindrical section. Until now such a gas generator housing has not been commercialised. The housing is not strong enough when an acceptable wall thickness is used.

Also by the present inventors several attempts to produce a gas generator housing of a polymer composition failed. Also in this case the generator housings were not strong enough to withstand the pressure in the combustion chamber after ignition of the propellant. Especially the reduced strength of the combustion chamber at elevated temperatures is a problem. This while the temperature in an automotive compartment may rise to a very high level, for example due to sun exposure.

Object of the present invention is to provide a gas generator housing for an air bag system comprising one or two parts of a fibre reinforced thermoplastic polymer composition, which gas generator housing is strong enough to withstand the explosive release of the gasses in the combustion chamber.

Surprisingly this object has been obtained if each part of the polymer composition is a hemispherical part.

Surprisingly such gas generator housing is strong enough to withstand the high pressures occurring upon ignition of the propellant. This is also true at elevated temperatures, while it is known that the mechanical properties of polymer compositions reduce considerably by raising the temperature. Furthermore it is possible to design the housing with an acceptable wall thickness, keeping the weight of the housing at an acceptable level.

Preferably the gas generator housing exists of two parts. Generally such a gas generator housing will be split in two parts at the largest internal diameter of the housing. This is to facilitate the release the parts of the housing from the mould, wherein it is produced.

If the gas generator housing comprises one hemispherical part of the polymer composition and the other part is made of a metal, preferably alumina, it is for example possible that the other part has a cylindrical shape or is a flat part. Preferably the other part is a flat part. This is because of the easiness of producing, filling and closing of the housing. Preferably both parts of the gas generator housing are of the polymer composition and are hemispherical parts. In that case the gas generator housing is entirely produced of the polymer composition and is entirely spherical.

Preferably one part of the polymer composition of the gas generator housing is integrated in the air bag container wall. This integration is one of the advantages of the gas generator housing according to the invention. Since air bag containers are generally made of a polymer composition, and since the gas generator housing according to the invention can surprisingly be produced from the same kind of compositions as used for the air bag housing, integration now becomes a possibility. The advantage of integration is that the combination of the gas container housing and the air bag container can be produced in less production steps and that a reduction in weight of the combination can be obtained.

Preferably the one part that is integrated in the air bag container is the part that contains the outflow openings for the gas.

As fibres for the polymer composition it is possible to use glass fibres, carbon fibres etc. Preferably glass fibres are used.

Preferably the polymer composition contains a polyamide, a polycarbonate, a polypropylene or a polyethylene terephthalate. More preferably the polymer composition contains a polyamide, even more preferably PA-6 or PA-66, most preferably PA-6. The fibre content of the polymer composition preferably is between 10 and 60 wt. %, more preferably between 25 and 50 wt. %. The fibres can be either short fibres, long fibres, non-woven or woven fabrics. Preferably the fibres are shot fibres. Compositions containing short fibres are produced by mixing chopped fibres, having a length of for example 6 or 12 mm, with the polymer of the composition in the molten stage. During the mixing in the molten stage the fibres break down to a shorter length. Compositions containing long fibres are generally produced by coating a fibre strand or a bundle of two or more glass fibre strands with the polymer and cutting the coated strand into a long fibre granulate, wherein the fibres extend in the length direction of the granulate and have the length of the granulate. The compositions containing short fibres or long fibres are normally processed into shaped objects by injection moulding. It is also possible that the composition is in the form of a sheet of a fabric or fibre mat impregnated with the polymer. Such sheets are normally processed into shaped objects by compression moulding.

Most preferably the composition consists of
42-75 wt. % PA-6
25-50 wt. % short glass fibres
0-8 wt. % of one or more further additives.
   A further additive may be an impact modifier, a pigment, a filler, a stabiliser, a mould release agent etc.

The wall thickness of the hemispherical part of the gas generator housing according to the invention may be between 1.5 and 6 mm. The wall thickness is preferably between 3.0 and 4.0 mm.

Preferably the gas generator housing of the invention is integrated with an air bag container of an air bag system for an instrument panel. The air bag in the instrument panel is installed for the protection of the passenger in the front seat. Such an air bag needs a high volume of gas and the integrated gas generator housing/air bag container is very suited for this air bag system.

After filling of the gas generator housing with the propellant it is possible to connect the parts of the housing by for example vibration welding or laser welding if both parts are from the polymer composition. If one part is made from the polymer composition and the other part is a metal part, than it is possible to connect the parts by using glue or screws.

The invention will further be explained by the Figures.

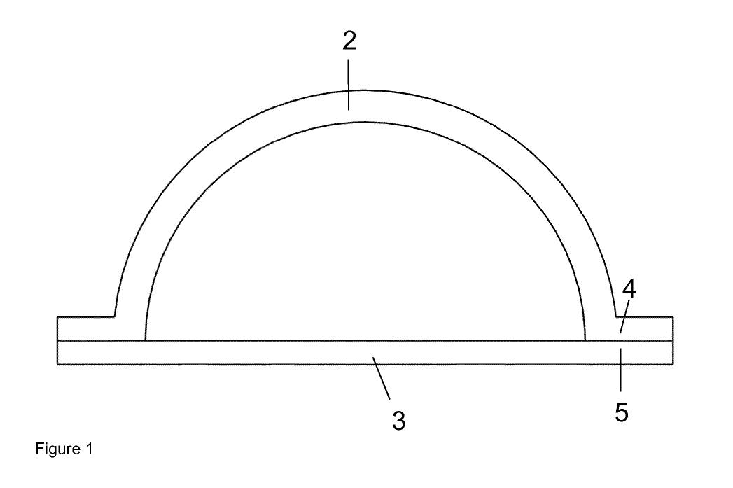

FIG. 1 shows a schematic view of a gas generator housing according to the invention having one hemispherical part.

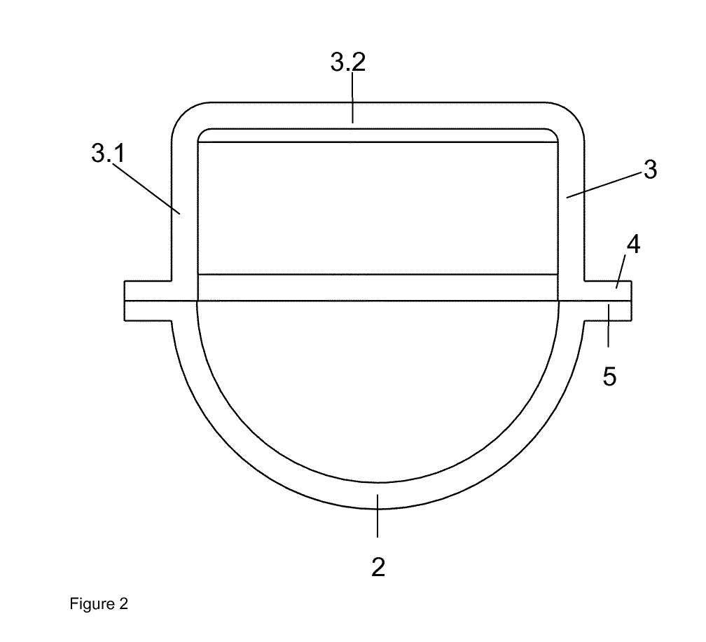

FIG. 2 shows a schematic view of a gas generator housing according to the invention having one hemispherical part.

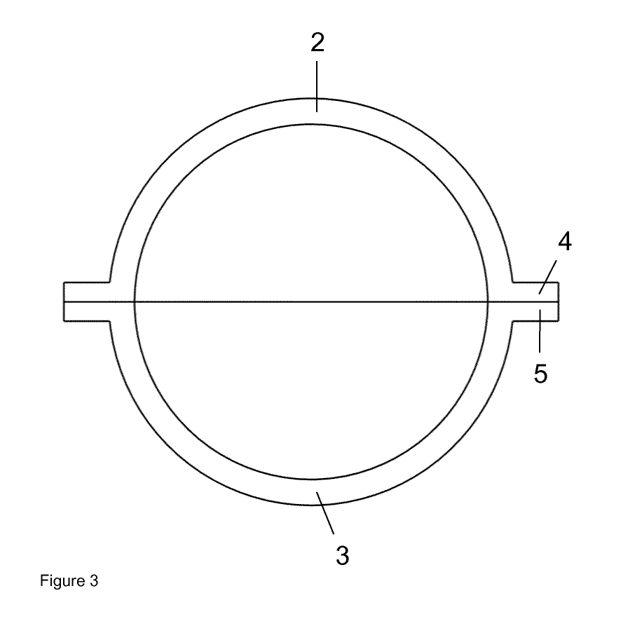

FIG. 3 shows a schematic view of a gas generator housing according to the invention having two hemispherical parts.

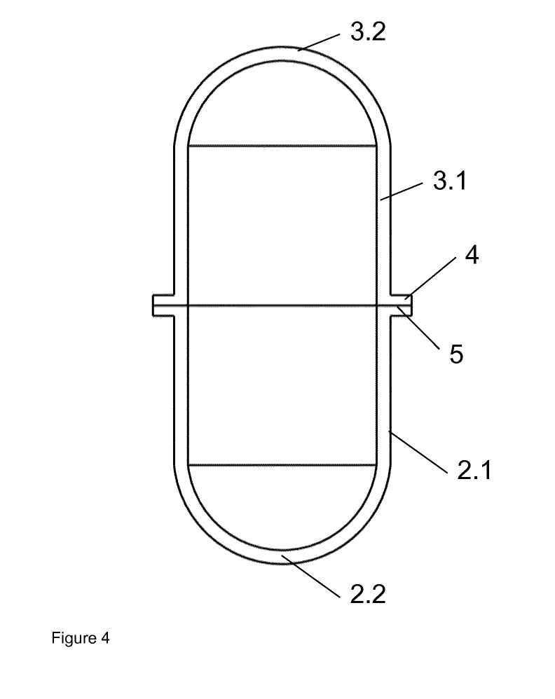

FIG. 4 shows a schematic view of a gas generator not according to the invention (see also comparative experiment C) having two parts. The parts are not hemispherical but have a spherical section and a cylindrical section.

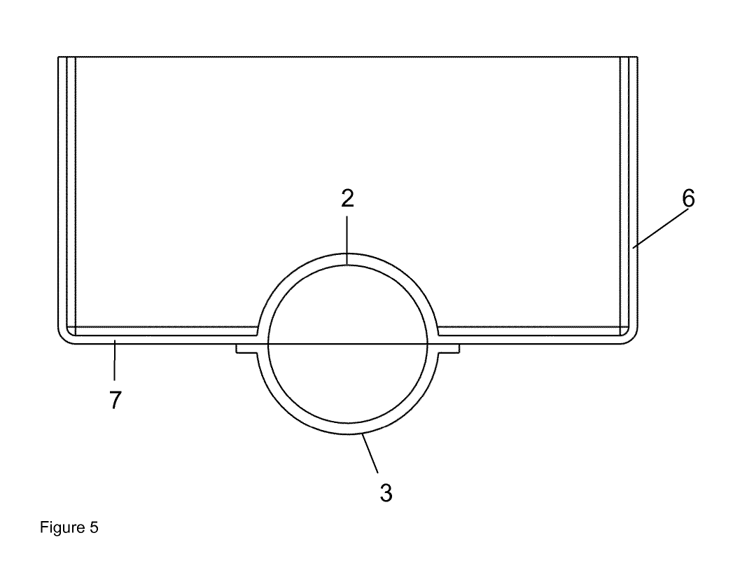

FIG. 5 shows a schematic view of a gas generator housing according to the invention integrated in bottom of the air bag container.

FIG. 1 shows a gas generator housing having one hemispherical part of the polymer composition (2) and a flat part of alumina (3). The parts are connected via surfaces (4) of the hemispherical part and surface (5) of the flat part.

FIG. 2 shows a gas generator housing having one hemispherical part of the polymer composition (2) and a cylindrical part of alumina (3). The cylindrical part contains a cylindrical section (3.1.) and a bottom (3.2). The parts are connected via surfaces (4) of the hemispherical part and surface (5) of the cylindrical part.

FIG. 3 shows a gas generator housing having a hemispherical part (2) and a hemispherical part (3), both of the polymer composition. The parts are connected via surfaces (4) and (5) of the hemispherical parts.

FIG. 4 shows a gas generator housing not according to the invention (see also comparative experiment C) of the polymer composition, having two parts (2) and (3). The parts have a spherical section (2.2. and 3.2) and a cylindrical section (2.1 and 3.1). The parts are connected via surfaces (4) and (5) of the parts.

FIG. 5 shows a gas generator housing and a container for an air bag (6). The gas generator housing contains a hemispherical part (2) that is integrated in the bottom (7) of the air bag container and one further hemispherical part (3).

### EXAMPLE I AND COMPARATIVE EXPERIMENT A, B AND C

### Example I

The gas generator housing according to FIG. 3 is produced from Akulon™ K224PG8, a polymer composition comprising a polyamide 6 and 40 wt. % of short glass fibers.

The wall thickness of the housing is 4 mm. The housing is filled with Nitrogen gas at a pressure of 25 MPa, at 23 and 85° C. The housing withstands the pressure at both temperatures.

### Comparative Experiments A, B and C

Housings having the shape of the housings of FIG. 1, FIG. 2 respectively FIG. 4 were produced. Contrary to what is indicated in the description of the Fig's all parts are now produced from a polymer composition, it is Akulon™ K224PG8, the same polymer composition as used in Example I. The housings are filled with Nitrogen gas at a pressure of 25 MPa, at 23 and 85° C. The housings burst at both temperatures at the side of the non-hemispherical part.

From example 1 and comparative experiments A, B and C it is clear that only hemispherical parts of the polymer composition survive in the test.

1. Gas generator housing for an air bag containing one or two parts from a fibre reinforced thermoplastic polymer composition, characterised in that each part of the polymer composition is a hemispherical part.

2. Gas generator housing according to claim 1, wherein the gas generator housing exists of two parts.

3. Gas generator housing according to claim 2, wherein one part of the gas generator housing is of the polymer composition and is a hemispherical part and the other part is from a metal.

4. Gas generator housing according to claim 2, wherein both parts of the gas generator housing are of the polymer composition and are hemispherical parts.

5. Gas generator housing according to claim 1, wherein one part of the polymer composition of the gas generator housing is integrated with the air bag container wall.

6. Gas generator housing according to claim 5, wherein the part that is integrated with the air bag container wall comprises the outflow openings for the gas.

7. Gas generator housing according to claim 1, wherein the polymer composition is a glass fibre reinforced thermoplastic polymer composition.

8. Gas generator housing according to claim 1, wherein as fibres short fibres are used.

9. Gas generator housing according to claim 1, wherein the polymer composition contains between 10-60 wt. % of fibres.

10. Gas generator housing according to claim 1, wherein the polymer composition contains PA-6.

11. Gas generator housing according to claim 1, wherein the housing has a wall thickness between 1.5 and 6 mm.
